(19) United States
(12) Patent Application Publication
(10) Pub. No.: US 2026/0163425 A1
(43) Pub. Date: Jun. 11, 2026

(54) ROTOR

(71) Applicant: TOYOTA JIDOSHA KABUSHIKI KAISHA, Toyota-shi (JP)

(72) Inventor: Ken JOZAKI, Seto-shi (JP)

(73) Assignee: TOYOTA JIDOSHA KABUSHIKI KAISHA, Toyota-shi (JP)

(21) Appl. No.: 19/286,729

(22) Filed: Jul. 31, 2025

(30) Foreign Application Priority Data
Dec. 6, 2024 (JP) 2024-213940

(51) Int. Cl. H02K 1/276

(52) U.S. Cl. CPC H02K 1/2766

(57) ABSTRACT

A rotor includes, in an outer peripheral portion, a rotor core including pairs of magnet insertion holes, a first magnet disposed closest to a radially inner side of the rotor core, and a second magnet disposed on the radially outer side to be spaced apart from the first magnet in at least one of the magnet insertion holes of each of the pairs along a direction that extends toward the radially outer side of the rotor core. The at least one of the magnet insertion holes includes, on an inner wall on the radially inner side of the rotor core in a gap between the first and second magnets, a protrusion portion that protrudes toward the radially outer side and is in contact with or is close to the first magnet so as to retain the first magnet, and a recessed portion recessed toward the radially inner side.

### CROSS-REFERENCE TO RELATED APPLICATION

This application claims priority to Japanese Patent Application No. 2024-213940 filed on Dec. 6, 2024. The disclosure of the above-identified application, including the specification, drawings, and claims, is incorporated by reference herein in its entirety.

### BACKGROUND

### 1. Technical Field

The technique disclosed in the present specification relates to a rotor.

### 2. Description of Related Art

A rotor including a rotor core, magnets disposed in magnet insertion holes provided in the rotor core, and mold materials retaining the magnets in the magnet insertion holes is disclosed (Japanese Unexamined Patent Application Publication No. 2024-66577 (JP 2024-66577 A)). In the rotor, pairs of magnet insertion holes that each extend to spread in a V-shape toward a radially outer side are provided, and a plurality of magnets is accommodated in each of the magnet insertion holes that extends in a radial direction toward the radially outer side.

### SUMMARY

The magnet insertion hole includes a gap that is filled with the mold material around the magnet disposed in the magnet insertion hole, and a protrusion portion that is in contact with the magnet to retain and position the magnet.

However, due to thermal stress during the manufacture of the rotor or a centrifugal force at the time of rotation of the rotor, stress may be concentrated on a specific portion of the magnet insertion hole. In particular, when the rotor core or the magnet thermally expands, the magnet may be pressed toward a center bridge portion side of the magnet insertion hole, so that stress tends to be concentrated on the center bridge portion side of the magnet insertion hole. Deformation and damage of the magnet resulting from such stress concentration is preferably reduced.

The present specification can provide a technique for suppressing stress concentration in a magnet insertion hole of a rotor core to suppress deformation of a magnet or the like.

A technique disclosed in the present specification is embodied in a rotor. The rotor core includes, in an outer peripheral portion, a plurality of pairs of magnet insertion holes, each of the pairs of the magnet insertion holes extending to spread in a V-shape toward a radially outer side, and a first magnet disposed closest to a radially inner side of the rotor core and a second magnet disposed on the radially outer side to be spaced apart from the first magnet in at least one of the magnet insertion holes of each of the pairs of the magnet insertion holes along a direction that extends toward the radially outer side of the rotor core.

The at least one of the magnet insertion holes includes, on an inner wall on the radially inner side of the rotor core in a gap between the first magnet and the second magnet, a protrusion portion that protrudes toward the radially outer side and is in contact with or is close to the first magnet from a second magnet side, the protrusion portion being able to retain the first magnet, and a recessed portion recessed toward the radially inner side on the second magnet side of the protrusion portion.

According to the rotor, providing the recessed portion on the second magnet side of the protrusion portion allows deformation of the protrusion portion with respect to the force applied from the first magnet to the protrusion portion. Therefore, the stress applied to the at least one of the magnet insertion holes and the stress applied to the first magnet are respectively suppressed. As a result, deformation or damage of the first magnet and the like is suppressed.

According to the related art, in the pair of the magnet insertion holes, stress tends to concentrate on a portion of the first magnet that is on the side closer to the center bridge portion between one of the magnet insertion holes of the pair and the other of the magnet insertion holes of the pair. However, because the recessed portion is provided on the second magnet side of the protrusion portion, as a result, the protrusion portion and the recessed portion can suppress the stress that tends to be concentrated on the center bridge portion side. Therefore, the stress on the center bridge portion side can be reduced, and the stress can be balanced between the center bridge portion side and the second magnet side in the first magnet. As a result, as described above, the deformation or damage of the first magnet and the like is suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view showing a magnet insertion hole and a retaining state of a magnet in a rotor core of a rotor disclosed in the present specification;

FIG. 2 is a diagram schematically showing the retaining state of the magnet in the magnet insertion hole; and

FIG. 3 is a diagram showing a state of stress in the magnet insertion hole.

### DETAILED DESCRIPTION OF EMBODIMENTS

A rotor (hereinafter, also referred to as the present rotor) disclosed in the present specification can adopt the following aspects in addition to the rotor.

In another aspect of the present rotor, the protrusion portion may include a wall portion that protrudes toward the radially outer side and is close to or in contact with the first magnet. The wall portion may have a first surface that is close to or in contact with the first magnet and a second surface on an opposite side of the first surface. The recessed portion may have an inner surface shape recessed toward the radially inner side such that the second surface is substantially parallel to the first surface. Accordingly, the recessed portion can be provided to be closest to the protrusion portion. As a result, the stress concentration around the first magnet can be more effectively suppressed in the recessed portion.

Another aspect of the present rotor may further include a retaining material disposed around the first magnet and the second magnet in the at least one of the magnet insertion holes. Further, the recessed portion may have an inclined portion inclined away from the protrusion portion and toward the second magnet side. Accordingly, in a case where the retaining material including the resin material is injected into and fills the at least one of the magnet insertion holes, the resin can be reliably injected into and fill the recessed portion. The presence of the inclined portion is significant in a case where the retaining material is used.

In another aspect of the present rotor, the at least one magnet insertion hole may further include one or more stress relaxation recessed portions that relax stress generated in the first magnet and are provided around the first magnet. As a result, the stress applied to the first magnet is further suppressed.

In another aspect of the present rotor, the stress relaxation recessed portion may be provided to face a corner portion of the first magnet. Accordingly, the stress in the corner portion can be effectively relaxed.

Hereinafter, embodiments of a rotor core disclosed in the present specification will be described with reference to the drawings as appropriate. In the present specification, when simply “radial direction” is used, it means the radial direction of the rotor core, when simply “circumferential direction” is used, it means the circumferential direction of the rotor core, and when simply “axial direction” is used, it means the axial direction of the rotor core.

In addition, in the present specification, the rotor is, for example, a motor generator having a function as an electric motor or a generator. For example, the rotor can constitute a drive source of a vehicle or the like by itself or together with an internal combustion engine.

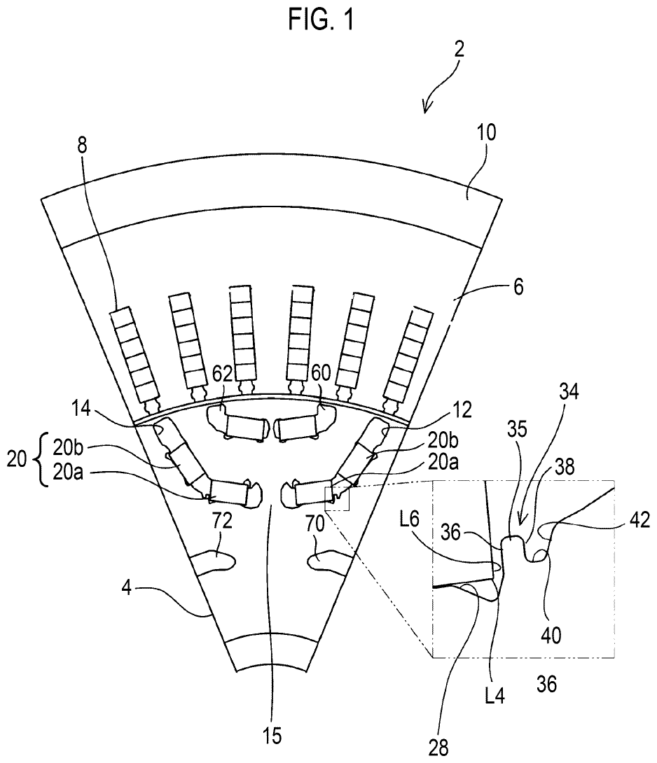

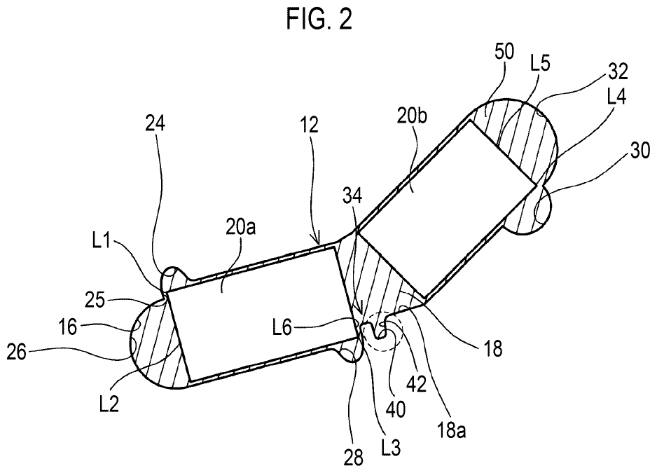

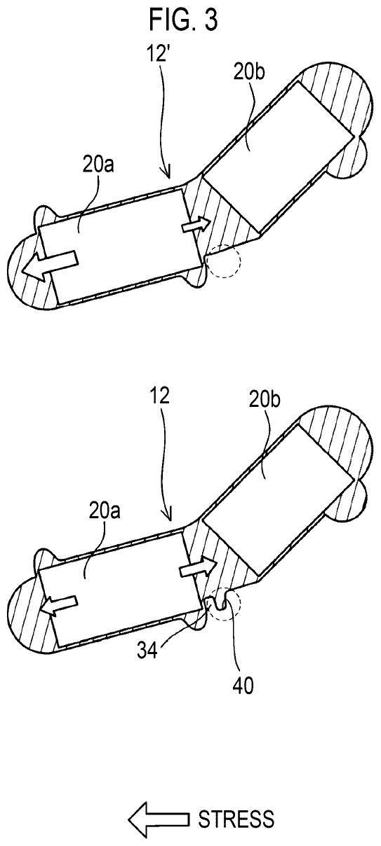

FIG. 1 shows a cross section of a portion of a rotor 2 disclosed in the present specification, the cross section being orthogonal to an axial direction of a rotor core 4. FIG. 2 shows a retaining state of magnets 20a, 20b in a magnet insertion hole 12. FIG. 3 shows a state of stress with respect to the magnet 20a and the like in the magnet insertion hole 12. Although FIGS. 1 to 3 are cross-sectional views, hatching indicating the cross section is omitted and in FIG. 1, a retaining material 50 made of a resin or the like for retaining a magnet 20 in the magnet insertion hole 12 is omitted.

As shown in FIG. 1, the rotor 2 includes the rotor core 4 and a plurality of the magnets 20 being retained in the rotor core 4. FIG. 1 shows a stator core 6 that surrounds the rotor 2, a coil 8 provided in the stator core 6, and a frame body 10 that surrounds an outer periphery of the stator core 6. Further, a shaft (not shown) is retained by a bearing 2a at the axial center of the rotor core 4. An axial end surface of the rotor core 4 and the other axial end surface may be sandwiched by an end plate or the like (not shown).

The rotor core 4 is not particularly limited, and is made of, for example, a laminated steel plate in which electromagnetic steel plates of a magnetic material, such as iron or an iron alloy, are laminated in the axial direction.

The rotor core 4 includes a plurality of sets of the magnet insertion holes 12, 14. More specifically, the rotor core 4 includes a plurality of sets of magnet insertion holes 12, 14 that extend to be spread in a V shape toward the radially outer side along the circumferential direction. For example, eight sets of the magnet insertion holes 12, 14 are provided. The magnet insertion holes 12, 14 extend from the radially inner side to the radially outer side and, with the center bridge portion 15 interposed therebetween, respectively constitute right and left sides having a V shape.

The V shape provided by the magnet insertion holes 12, 14 is not particularly limited. The V shape may be configured to be spread linearly from the radially inner side to the radially outer side, or may be provided to be spread in a curved shape as shown in FIG. 1.

The magnet insertion holes 12, 14 are provided to penetrate the rotor core 4 in the axial direction. In each of the magnet insertion holes 12, two magnets 20 (hereinafter, referred to as 20a, 20b in order from the radially inner side) are retained.

Here, the magnets 20a, 20b retained by the magnet insertion holes 12 will be described. The magnets 20a, 20b are not particularly limited, and for example, a known permanent magnet is used. Each of the magnets 20a, 20b has an elongated shape extending along the axial direction. In addition, a cross section of the magnets 20a, 20b perpendicular to the axial direction of the magnets 20a, 20b includes, for example, a rectangular shape as shown in FIG. 1. The magnets 20a, 20b are examples of the first magnet and the second magnet disclosed in the present specification.

Since the magnet insertion holes 12, 14 shown in FIG. 1 have a right and left symmetrical configuration with the center bridge portion 15 as an intermediate portion, the magnet insertion hole 12 will be described below.

In the magnet insertion hole 12, as shown in FIGS. 1 and 2, the magnets 20a, 20b are disposed in order from the radially inner side to the radially outer side. More specifically, long end faces corresponding to long sides of cross sections of each of the magnets 20a, 20b are retained to extend in an extension direction toward the radially outer side of the magnet insertion hole 12. The magnets 20a, 20b are disposed in the magnet insertion hole 12 with a gap 18 that is predetermined. In FIG. 1, since the magnet insertion hole 12 has a curved shape extending toward the radially outer side, the gap 18 has an inner surface shape that is curved or bent between the two magnets 20a, 20b.

As shown in FIG. 2, the retaining material 50 is filled in the magnet insertion hole 12 such that a space between the magnets 20a, 20b and an inner wall surface of the magnet insertion hole 12 is filled with the retaining material 50. The retaining material 50 is not particularly limited as long as the retaining material has a certain fluidity and can be injected into the gap between such as the magnet 20a and the inner wall surface of the magnet insertion hole 12, and can be cured by, for example, heat treatment or the like to fill the gap. For example, the retaining material 50 can include a resin material, such as a thermosetting resin or a thermoplastic resin.

An inner wall portion 16 of the magnet insertion hole 12 has a shape suitable for retaining the magnets 20a, 20b. As shown in FIG. 2, the inner wall portion 16 of the magnet insertion hole 12 includes stress relaxation recessed portions 24, 26, 28, 30, 32. The stress relaxation recessed portions 24, 26, 28, 30, 32 are all provided to extend along the axial direction.

The stress relaxation recessed portions 24, 26, 28 are provided to relax stress generated by thermal stress or centrifugal force around the magnet 20a. The thermal stress may be generated during the manufacture of the rotor 2, such as the injection and heat treatment of the retaining material 50 and the welding of the laminated steel plates of the rotor core 4. In addition, the centrifugal force may be generated by the rotation of the rotor 2.

The stress relaxation recessed portion 24 is provided to face a long end surface in the vicinity of the corner portion L1 on the radially outer side with respect to the center bridge portion 15 of the magnet 20a at the proximal portion. The stress relaxation recessed portion 26 is provided to face a short end surface corresponding to a short side L2 of the magnet 20a positioned on the most radially inner side. A retaining portion 25 that is in contact with or close to the short end surface of the magnet 20a in the vicinity of the corner portion L1 of the magnet 20a is provided between the stress relaxation recessed portion 24 and the stress relaxation recessed portion 26, and the retaining portion 25 can retain and position the magnet 20a.

The stress relaxation recessed portion 28 is provided to face the long end surface in the vicinity of the corner portion L3 on the distal end portion with respect to the center bridge portion 15 of the magnet 20a on the radially inner side. The stress relaxation recessed portions 24, 26, 28 are all provided in a recessed shape toward the inside of the rotor core 4 so as to draw a gentle curved surface, and are configured to relax the stress around the magnet 20a.

The stress relaxation recessed portions 30, 32 are provided to relax the stress generated by the various factors described above around the magnet 20b. The stress relaxation recessed portion 30 is provided to face the long end surface in the vicinity of the corner portion L4 on the distal end portion with respect to the center bridge portion 15 of the magnet 20b on the radially inner side. The stress relaxation recessed portion 32 is provided to face the short end surface corresponding to the short side L5 of the magnet 20b positioned on the most radially outer side. The stress relaxation recessed portions 30, 32 are all provided in a recessed shape toward the inside of the rotor core 4 so as to draw a gentle curved surface, and are configured to relax the stress around the magnet 20b.

As shown in FIGS. 1 and 2, the gap 18 between the magnet 20a and the magnet 20b includes a protrusion portion 34 that can retain the magnet 20a. The protrusion portion 34 is provided on an inner wall part 18a on the radially inner side of the gap 18. The protrusion portion 34 includes the wall portion 35 configured to retain and position the magnet 20a by being in contact with or close to, an area that is predetermined a short end surface L6 extending from the corner portion L3 of the magnet 20a, from the radially outer side or a magnet 20b side.

The wall portion 35 includes a surface 36 facing the short end surface L6 and a surface 38 on the opposite side of the surface 36. The surface 38 is exposed to the magnet 20b side in the gap 18. The surface 36 and the surface 38 are substantially parallel to each other, and the wall portion 35 is a wall-like body having a substantially constant thickness. The height and the thickness of the wall portion 35 may be set to be able to function as the protrusion portion 34, and for example, the thickness may be in a range of 0.3 mm or more and 2 mm or less. The surfaces 36, 38 are examples of the first surface and the second surface disclosed in the present specification, respectively.

The magnet insertion hole 12 includes a recessed portion 40. The recessed portion 40 is provided adjacent to the magnet 20b side of the protrusion portion 34. The recessed portion 40 is provided, in the magnet insertion hole 12, to be recessed from the inner wall part 18a toward the radially inner side, that is, to be away from the protrusion portion 34 or the inner wall part 18a.

The recessed portion 40 is provided in a narrow groove shape in general, unlike the stress relaxation recessed portions 24, 26, 28, 30, 32 having a recessed shape that is greatly curved. Accordingly, the deformation of the protrusion portion 34 can be effectively allowed, and the stress concentration around the magnet 20a can be suppressed. For example, as shown in FIG. 2, the recessed portion 40 is provided in an inner surface shape in which the surface 38 that is substantially parallel to the surface 36 of the wall portion 35 is recessed toward the radially inner side. Accordingly, the recessed portion 40 can be provided to be most adjacent to the protrusion portion 34. As a result, the deformation of the protrusion portion 34 can be effectively allowed, and the stress concentration generated around the magnet 20a by the recessed portion 40 can be suppressed.

As shown in FIGS. 1 and 2, the recessed portion 40 includes an inclined portion 42 inclined away from the protrusion portion 34 and toward the magnet 20b side. The inclined portion 42 is inclined such that an opening of the recessed portion 40 expands toward the magnet 20b side. Accordingly, when the retaining material 50 is injected, the recessed portion 40 can be easily filled with the retaining material 50.

The shape and size of a recess of the recessed portion 40 are not particularly limited as long as the shape and size allow the deformation of the protrusion portion 34 and the suppression of the stress concentration around the magnet 20a. For example, the opening can be provided in the inner wall part 18 a in a groove shape in a range of 0.3 mm or more and 2 mm or less in width.

Further, another pair of magnet insertion holes 60, 62 may be provided on the radially outer side of the V shaped inner sides of the magnet insertion holes 12, 14 of the rotor core 4. In addition, a suitable number of refrigerant flow paths 70, 72 may be provided along the circumferential direction on the radially inner side of the magnet insertion holes 12, 14.

The action of suppressing stress concentration in the magnet insertion hole 12 of the rotor 2 will be described. The upper part of FIG. 3 shows a state in a magnet insertion hole 12′ having the same configuration as the above except that the recessed portion 40 is not provided, and the lower part of FIG. 3 shows a state in the magnet insertion hole 12 including the recessed portion 40.

As shown in the upper part of FIG. 3, in the magnet insertion hole 12′ in the related art, the stress derived from the various factors described above tends to be concentrated in the vicinity of the short end surface corresponding to the short side L2 of the magnet 20a.

On the other hand, as shown in the lower part of FIG. 3, with the rotor core 4 including the recessed portion 40, the recessed portion 40 is provided, and the recessed portion 40 becomes a kind of fragile portion, so that the deformation of the protrusion portion 34 is allowed. Since the deformation of the protrusion portion 34 is allowed, for example, when the rotor core 4 and the magnet 20a thermally expand, the amount of displacement of the short side L2 of the magnet 20a to the center bridge portion 15 side is suppressed. Therefore, the stress at the vicinity of the short end surface corresponding to the short side L2 of the magnet 20a can be reduced. As a result, the stress concentration around the magnet 20a can be suppressed, and deformation of the magnet 20a can be suppressed. At the same time, since the stress concentration on the center bridge portion 15 is suppressed, the center bridge portion 15 can be narrowed, and the maximum rotation speed of the rotor 2 can be increased.

In the above-described embodiment, the recessed portion 40 is provided in a groove shape on the magnet 20b side adjacent to the protrusion portion 34 that retains the magnet 20a. Therefore, the deformation of the protrusion portion 34 can be effectively allowed, and the stress concentration around the magnet 20a can be more effectively suppressed. In addition, in the above-described embodiments, it is assumed that each of the magnet insertion holes 12, 14 provided in the rotor 2 has the same configuration. However, a part of the magnet insertion holes 12, 14 or at least one of the magnet insertion holes 12, 14 provided in the rotor 2 may include the recessed portion 40.

In addition, the recessed portion 40 of the rotor core 4 includes an inclined portion 42. Therefore, when the retaining material 50 made of the resin material is injected around the magnet 20a or the like and cured, the retaining material 50 is easily filled in the recessed portion 40, and the fillability of the retaining material 50 can be improved.

In addition to the recessed portion 40, the rotor core 4 includes the stress relaxation recessed portions 24, 26, 28, 30, 32 in the magnet insertion holes 12, and thus the stress generated in various situations can be dispersed in the rotor core 4.

In the above-described embodiment, the recessed portion 40 is provided with the inner surface shape in which the surface 38 that is substantially parallel to the surface 36 of the wall portion 35 is recessed toward the radially inner side, but the present disclosure is not limited thereto. The recessed portion 40 may have an inner surface shape in which the surface 38 is inclined to be gradually spaced apart from the surface 36 from the top of the wall portion 35 and is recessed toward the radially inner side.

In addition, in the above-described embodiments, the stress relaxation recessed portions 24, 26, 28, 30, 32 are provided, but at least a part of the stress relaxation recessed portions may be provided. The configuration of the stress relaxation recessed portion can be changed as needed.

In addition, in the above-described embodiments, the retaining material 50 including the resin material is used, but the present disclosure is not limited thereto. Various other known retaining means can be appropriately used.

The present specification includes the following items based on the above description.
[1] A rotor including:
a rotor core including, in an outer peripheral portion, a plurality of pairs of magnet insertion holes each of the pairs of the magnet insertion holes extending to spread in a V-shape toward a radially outer side; and
a first magnet disposed closest to a radially inner side of the rotor core and a second magnet disposed on the radially outer side to be spaced apart from the first magnet in at least one of the magnet insertion holes of each of the pairs of the magnet insertion holes along a direction that extends toward the radially outer side of the rotor core,
in which the at least one of the magnet insertion holes includes, on an inner wall on the radially inner side of the rotor core in a gap between the first magnet and the second magnet, a protrusion portion that protrudes toward the radially outer side and is in contact with or is close to the first magnet from a second magnet side, the protrusion portion being able to retain the first magnet, and a recessed portion recessed toward the radially inner side on the second magnet side of the protrusion portion.
[2] In the rotor according to [1],
the protrusion portion includes a wall portion that protrudes toward the radially outer side and is close to or in contact with the first magnet, the wall portion having a first surface that is close to or in contact with the first magnet and a second surface on an opposite side of the first surface; and
the recessed portion has an inner surface recessed toward the radially inner side such that the second surface is substantially parallel to the first surface.
[3] The rotor according to [1] or [2], further including a retaining material disposed around the first magnet and the second magnet in the at least one of the magnet insertion holes, in which the recessed portion includes an inclined portion inclined away from the protrusion portion and toward the second magnet side.
[4] In the rotor according to any one of [1] to [3], the at least one of the magnet insertion holes further includes one or more stress relaxation recessed portions that relax stress generated in the first magnet and are provided the first magnet.
[5] In the rotor according to [4], the stress relaxation recessed portion is provided to face a corner portion of the first magnet.

Although specific examples of the technology disclosed in the present specification have been described in detail above, these examples are merely illustrative and do not limit the scope of the claims. The technology described in the claims includes various modifications and changes of the specific examples exemplified above. The technical elements described in the present specification or the drawings exhibit technical usefulness alone or in various combinations, and are not limited to the combinations described in the claims at the time of filing. The technology exemplified in the present specification or the drawings can achieve a plurality of objectives at the same time, and achieving one of the objectives has technical usefulness.

What is claimed is:

1. A rotor comprising:
a rotor core including, in an outer peripheral portion, a plurality of pairs of magnet insertion holes, each of the pairs of the magnet insertion holes extending to spread in a V-shape toward a radially outer side; and
a first magnet disposed closest to a radially inner side of the rotor core and a second magnet disposed on the radially outer side to be spaced apart from the first magnet in at least one of the magnet insertion holes of each of the pairs of the magnet insertion holes along a direction that extends toward the radially outer side of the rotor core,
wherein the at least one of the magnet insertion holes includes, on an inner wall on the radially inner side of the rotor core in a gap between the first magnet and the second magnet,
a protrusion portion that protrudes toward the radially outer side and is in contact with or is close to the first magnet from a second magnet side, the protrusion portion being able to retain the first magnet, and
a recessed portion recessed toward the radially inner side on the second magnet side of the protrusion portion.

2. The rotor according to claim 1, wherein:
the protrusion portion includes a wall portion that protrudes toward the radially outer side and is close to or in contact with the first magnet, the wall portion having a first surface that is close to or in contact with the first magnet and a second surface on an opposite side of the first surface; and
the recessed portion has an inner surface shape recessed toward the radially inner side such that the second surface is substantially parallel to the first surface.

3. The rotor according to claim 1, further comprising a retaining material disposed around the first magnet and the second magnet in the at least one of the magnet insertion holes, wherein the recessed portion includes an inclined portion inclined away from the protrusion portion and toward the second magnet side.

4. The rotor according to claim 1, wherein the at least one of the magnet insertion holes further includes one or more stress relaxation recessed portions that relax stress generated in the first magnet and are provided around the first magnet.

5. The rotor according to claim 4, wherein the stress relaxation recessed portion is provided to face a corner portion of the first magnet.
